(19) United States
(12) Patent Application Publication
(10) Pub. No.: US 2003/0147253 A1
(43) Pub. Date: Aug. 7, 2003

(54) Curved warning light device for attaching to vehicle

(76) Inventor: Jack Shy, Chang Hua (TW)

Correspondence Address: Jack SHY, 7F, No. 46, Pin Ho 10 Street, Chang Hua, 500, TW

(21) Appl. No.: 10/066,576

(22) Filed: Feb. 6, 2002

(51) Int. Cl. F21V 21/00

(52) U.S. Cl. 362/545; 362/540; 362/544; 362/521; 362/244

(57) ABSTRACT

A warning light device for attaching onto various portions of vehicles includes a housing having a base plate and a cover secured together and having a bent portion for attaching onto curved portions of the vehicle. One or more circuit boards are received in the housing, and a number of of light devices are attached to the circuit boards and facing forward and sidewise and rearward of the housing for generating lights to be seen from various directions of the vehicle. One or more panels are attached onto the circuit boards and have concentric circles for light diffusing purposes.

### BACKGROUND OF THE INVENTION

1. Field of the Invention

The present invention relates to a warning light device, and more particularly to a warning light device having a curved structure for solidly attaching onto the curved portions of the vehicle.

2. Description of the Prior Art

Various kinds of typical warning light devices have been developed for attaching onto the vehicles. U.S. Pat. No. 5,193.895 to Naruke et al., discloses one of the typical warning light devices including a flexible structure for attaching onto various portions of the vehicles. Though the flexible warning light device may be attached onto various portions of the vehicles, the flexible warning light device may not be suitably bent and attached onto the curved portions of the vehicle, such as the rear view mirrors, the bumpers, etc. The flexible warning light device that are attached and secured onto the curved portions of the vehicle with such as the adhesive layers or materials may not be solidly secured to the vehicle and may be easily disengaged from the vehicle due to the resilience of the flexible warning light device.

The present invention has arisen to mitigate and/or obviate the afore-described disadvantages of the conventional warning light devices.

### SUMMARY OF THE INVENTION

The primary objective of the present invention is to provide a warning light device including a curved structure for solidly attaching onto the curved portions of the vehicle and for preventing the warning light device from being easily disengaged from the vehicle.

In accordance with one aspect of the invention, there is provided a warning light device for attaching onto various portions of vehicles, the warning light device comprising a housing including a base plate having a chamber formed therein, and a cover secured in front of the base plate, the base plate and the cover including a bent portion for allowing the housing to be attached onto curved portions of the vehicle, a first circuit board received in the chamber of the base plate, and including a front portion facing toward the cover, a second circuit board received in the chamber of the base plate and received in the bent portion of the base plate, and a plurality of light devices attached to the first and the second circuit boards respectively, the light devices attached on the first circuit board being facing forward of the housing, and the light devices attached on the second circuit board being facing sidewise and rearward of the housing for generating lights to be seen from various directions of the vehicle.

The base plate includes at least one pin extended inward of the chamber thereof, the first circuit board includes at least one orifice formed therein for receiving the pin and for securing to the base plate.

The base plate includes at least one fence provided in the bent portion thereof, the second circuit board is engaged with the fence for being secured to the base plate.

The base plate includes an outer peripheral portion having a peripheral flange extended forward therefrom, the cover includes an outer peripheral portion having a peripheral flange extended rearward therefrom and engaged with the peripheral flange of the base plate.

The peripheral flanges of the base plate and the cover are preferably secured together with such as an ultrasonic welding process.

A first and a second panels are further provided and attached onto the first and the second circuit boards respectively.

The first and the second panels each includes a plurality of light diffusing devices disposed in front of the light devices respectively, and each having a plurality of concentric circles formed therein.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a warning light device in accordance with the present invention;

FIG. 2 is a partial exploded view of the warning light device;

FIG. 3 is an exploded view of the warning light device;

FIG. 4 is a partial exploded view illustrating the other embodiment of the warning light device;

FIG. 5 is a cross sectional view taken along lines 5-5 of FIG. 1;

FIG. 6 is a cross sectional view similar to FIG. 5, illustrating the operation of the warning light device;

FIG. 7 is a cross sectional view taken along lines 7-7 of FIG. 1, illustrating the operation of the warning light device;

FIG. 8 is a partial plan view illustrating the operation of the warning light device;

FIG. 9 is an exploded view illustrating the further embodiment of the warning light device;

FIG. 10 is a cross sectional view of the warning light device as shown in FIG. 9;

FIG. 11 is a perspective view illustrating the operation of the warning light device;

FIG. 12 is a partial perspective view illustrating the operation of the warning light device; and

FIGS. 13 and 14 are partial plan views illustrating the operation of the warning light device;

### DETAILED DESCRIPTION OF THE PREFERRED EMBODIMENT

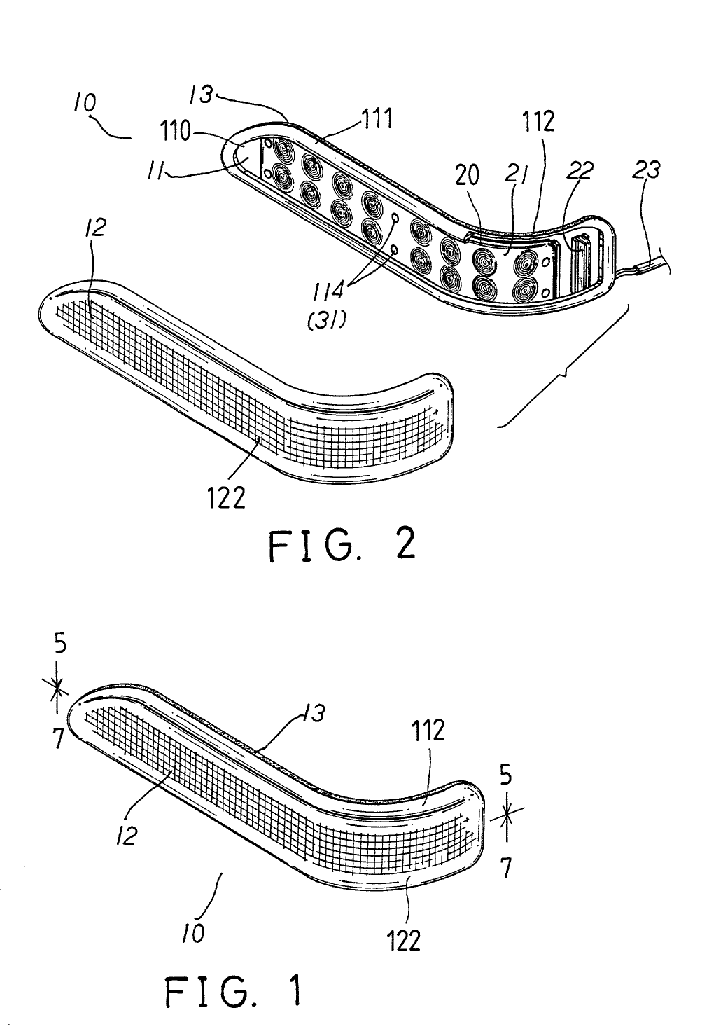

Referring to the drawings, and initially to FIGS. 1-5, a warning light device in accordance with the present invention comprises a housing 10 including a base plate 11 having a peripheral flange 111 extended forward from the outer peripheral portion thereof for forming or defining a chamber 110 therein, and having one or more pins 114 extended inward of the chamber 110 thereof, and having a bent portion or a bent side portion 112 formed in the middle portion or in one end thereof, and having one or more fences 113 extended inward of the chamber 110 thereof and located close to or disposed in the bent portion 112 thereof.

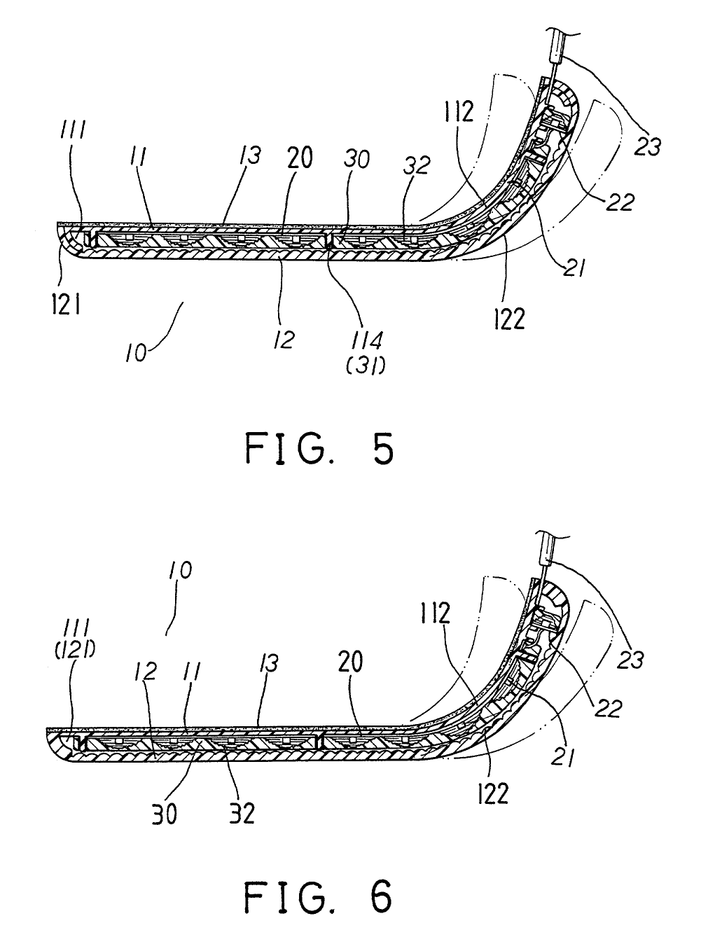

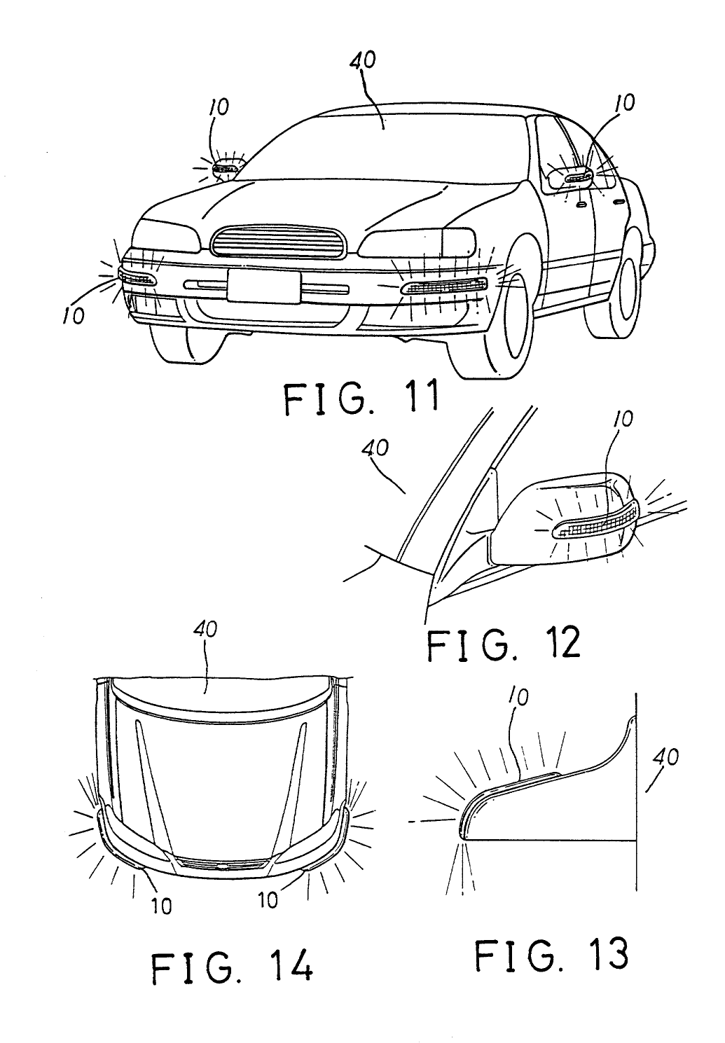

The housing 10 further includes a cover 12 having a peripheral flange 121 extended rearward from the outer peripheral portion thereof for engaging with the peripheral flange 111 of the base plate 11 (FIG. 5) and for securing to the peripheral flange 111 of the base plate 11 with such as a welding or ultrasonic welding process (FIG. 6), and for allowing the cover 13 to be solidly secured onto the base plate 11 in a water-tight and an air-tight seal. The cover 13 also includes a bent portion or bent side portion 122 formed in the middle portion or in one end thereof, corresponding to the bent portion 112 of the base plate 11, for allowing the housing 10 to include a predetermined curvature formed and provided therein, and for attaching onto the curved portions of the vehicle, such as the bumpers (FIGS. 11, 14), the rear view mirrors (FIGS. 12, 13) of the vehicle.

As best shown in FIGS. 5 and 6, the base plate 11 and the cover 13 of the housing 10 are made of flexible materials, such that the bent portions 112, 122 of the base plate 11 and the cover 13 of the housing 10 may be slightly bent according to the curvature of the vehicle portions, for allowing the housing 10 to be solidly attached onto the various curved portions of the vehicle without being easily disengaged from the vehicle. The base plate 11 and the cover 13 of the housing 10 are also preferably made of transparent or semi-transparent materials, for allowing lights to be transmitted through the base plate 11 and the cover 13.

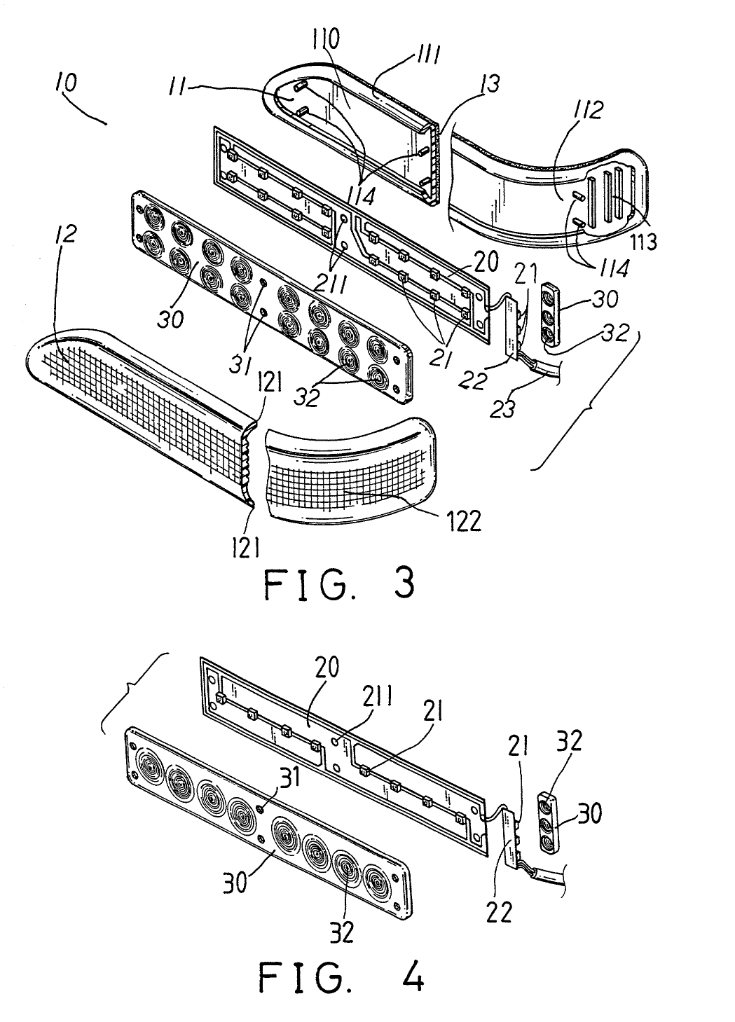

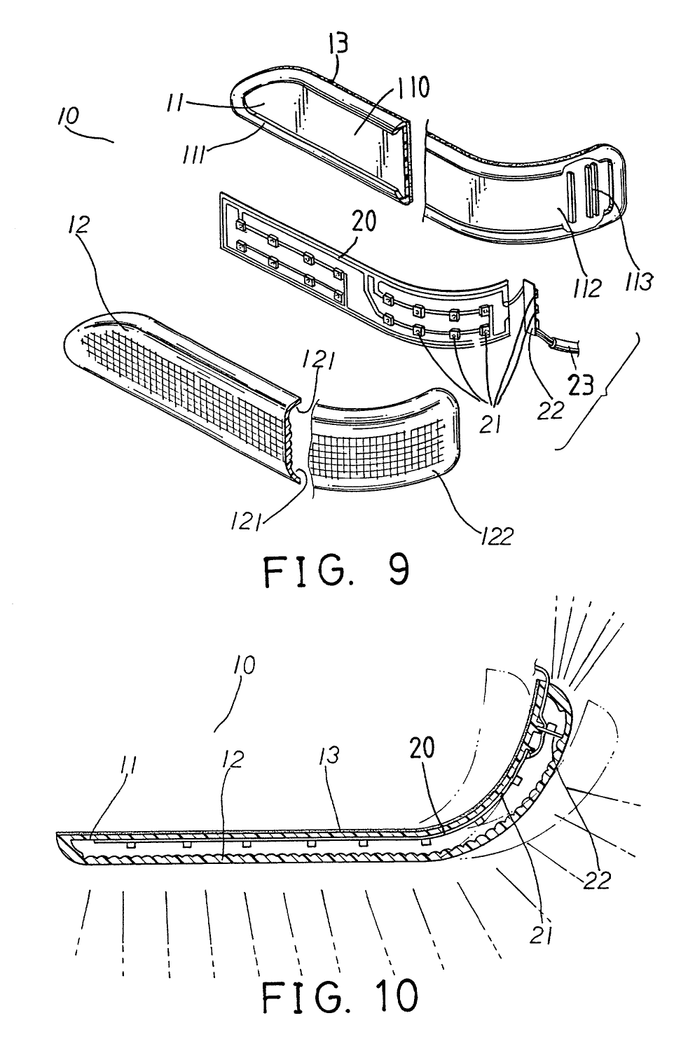

A circuit board 20 is engaged into the chamber 110 of the base plate 11, and includes one or more orifices 211 formed therein for receiving the pins 114 and for securing to the base plate 11. One or more further circuit boards 22 are further provided and coupled to the circuit board 20 and coupled to the electric power source of the vehicle with such as the electric wires 23. The circuit boards 22 may be secured to the base plate 11 with such as the fences 113. The circuit boards 20, 22 each includes a number of light devices 21 attached thereto for generating lights, particularly the warning lights. The light devices 21 may be arranged in one (FIG. 4) or more rows (FIGS. 3, 9).

One or more panels 30 are further provided and attached onto the circuit boards 20, 22 respectively, and each includes a number of light diffusing devices 32 provided thereon and aligned with the light devices 21 for light diffusing purposes. For example the light diffusing devices 32 each includes a number of concentric circles or ribs and grooves formed therein for diffusing the lights generated by the light device 21, and for allowing the lights to be clearly seen from a wider angle. The panels 30 and the light diffusing devices 32 are optional and may be selectively attached in front of the circuit boards 20, 22. For example, as shown in FIGS. 9 and 10, no panels 30 are attached in front of the circuit boards 20, 22. The panels 30 each includes one or more apertures 31 formed therein for receiving the pins 114 and for securing to the base plate 11.

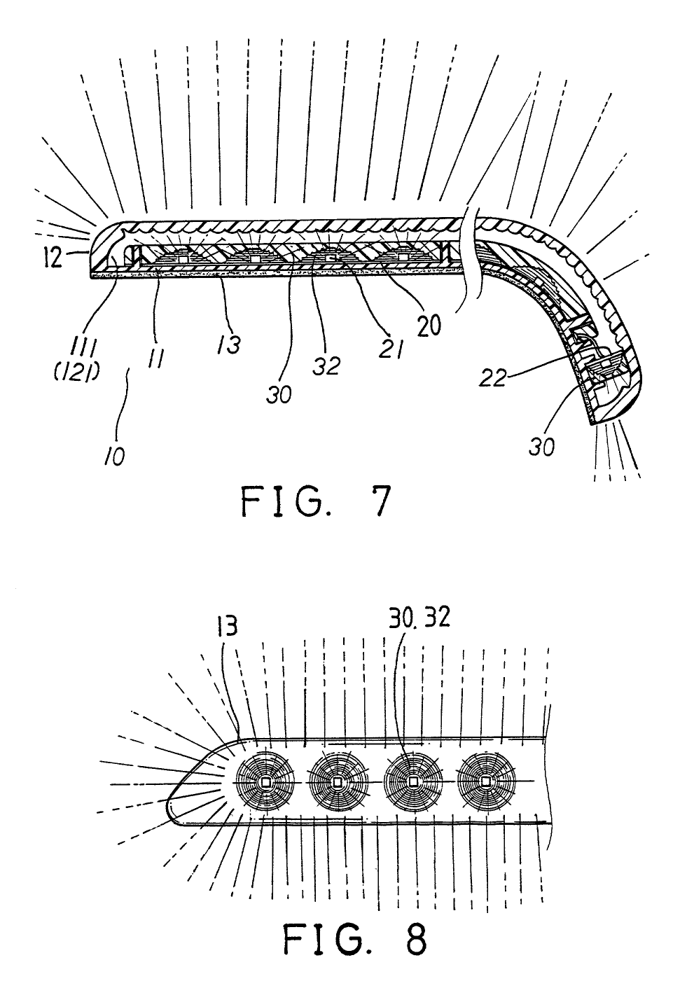

In operation, as shown in FIGS. 5-7, the light devices 21 attached onto the circuit board 20 may be directed forward of the vehicle, for example, for generating lights to be seen from the front portion of the vehicle. The light devices 21 attached onto the other circuit boards 22 may be directed sidewise and/or rearward of the vehicle, for example, for generating lights to be seen from the side portion and the rear portion of the vehicle. The diffusing devices 32 of the panels 30 may diffuse the lights for allowing the lights to be clearly seen from various angles of the vehicle.

Accordingly, the warning light device in accordance with the present invention includes a curved structure for solidly attaching onto the curved portions of the vehicle and for preventing the warning light device from being easily disengaged from the vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A warning light device for attaching onto various portions of vehicles, said warning light device comprising:
a housing including a base plate having a chamber formed therein, and a cover secured in front of said base plate, said base plate and said cover including a bent portion for allowing said housing to be attached onto curved portions of the vehicle,
a first circuit board received in said chamber of said base plate, and including a front portion facing toward said cover,
a second circuit board received in said chamber of said base plate and received in said bent portion of said base plate, and
a plurality of light devices attached to said first and said second circuit boards respectively, said light devices attached on said first circuit board being facing forward of said housing, and said light devices attached on said second circuit board being facing sidewise and rearward of said housing for generating lights to be seen from various directions of the vehicle.

2. The warning light device according to claim 1, wherein said base plate includes at least one pin extended inward of said chamber thereof, said first circuit board includes at least one orifice formed therein for receiving said at least one pin and for securing to said base plate.

3. The warning light device according to claim 1, wherein said base plate includes at least one fence provided in said bent portion thereof, said second circuit board is engaged with said at least one fence for being secured to said base plate.

4. The warning light device according to claim 1, wherein said base plate includes an outer peripheral portion having a peripheral flange extended forward therefrom, said cover includes an outer peripheral portion having a peripheral flange extended rearward therefrom and engaged with said peripheral flange of said base plate.

5. The warning light device according to claim 4, wherein said peripheral flanges of said base plate and said cover are secured together with a welding process.

6. The warning light device according to claim 1 further comprising a first and a second panels attached onto said first and said second circuit boards respectively.

7. The warning light device according to claim 6, wherein said first and said second panels each includes a plurality of light diffusing devices disposed in front of said light devices respectively, and each having a plurality of concentric circles formed therein.
